(19) United States
(12) Patent Application Publication
(10) Pub. No.: US 2011/0038272 A1
(43) Pub. Date: Feb. 17, 2011

(54) GENERALIZED EESM SYSTEM AND METHOD

(76) Inventors: Zion Hadad, Rishon-lezion (IL); Doron Ezri, Tel Aviv (IL); Michael Erlihson, Tel Aviv (IL)

Correspondence Address: ROBERT G. LEV, 4766 MICHIGAN BLVD., YOUNGSTOWN, OH, 44505, US

(21) Appl. No.: 12/735,318

(22) PCT Filed: Dec. 23, 2008
(86) PCT No.: PCT/IL08/01659

§ 371 Date: Oct. 12, 2010

(30) Foreign Application Priority Data
Dec. 31, 2007 (IL) 188503
Dec. 31, 2007 (IL) 188504

(51) Int. Cl. H04L 12/26

(52) U.S. Cl. 370/252

(57) ABSTRACT

A method for computing ECINR in communication systems, by calculating or measuring instantaneously CINR (yi) or per-tone CINR value for each channel and/or bandwidth and/or signal of interest, selecting κ and β parameters according to MCS and/or FEC block size used, calculating ECINR by using the CINR ((yi) or per-tone CINR values and the κ and β parameters with a generalized EESM formula, and providing a communication system with the updated γeff which is the ECINR value.

### FIELD OF THE INVENTION

This invention relates to noise and interference estimation in communications systems and especially to a generalized EESM system and method for Effective CINR calculation.

### BACKGROUND OF THE INVENTION

In communications systems, it may be important to evaluate noise and interferences. This may be important in order to appraise system's performance and capabilities, estimate the minimal power required for transmission, control the data rate, encoding and setting Forward Error Correction (FEC) Code, decide what Modulation Coding Scheme (MCS) to use and what are the system's concurrent limitations. For example, when there is more noise and signals' interference, a more robust modulation may be selected, such as BPSK or QPSK. When the channel has less noise and interference, 16-QAM, 64-QAM, etc. may be used—for transferring more data in each symbol.

Thus, better knowledge of this information will enable providing a more efficient communication system, matched to provide improved performance based on known limitations.

Providing and improving the setup for the system, such as either in a Base Station BS and/or in a Mobile Station MS, may be difficult to find. Furthermore, in a system compatible with a relatively wider frequency spectrum, such as Orthogonal Frequency Division Multiple Access OFDMA, WIMAX or equivalent system, channel response may vary with frequency, thus a method for determining overall channel behavior is required. Many communication systems include pilot signals, however there is a problem how to derive effective decisions based on these pilots.

Having a broadband channel may reveal different characteristics along frequencies and varying channel to interference and noise ratio (CINR) with frequency, time, location and method of communication.

It may be of high importance to calculate an effective CINR (ECINR), which relates to the overall characteristics of the channel and/or is based on some frequency spectra. The ECINR takes the channel variations into consideration.

Calculating ECINR better, would yield better channel throughput—providing more data and/or less power.

For example, in OFDMA systems it may be possible that a mobile station MS and/or a Base Station BS, would measure and use CINR and further compute ECINR. Using the ECINR, better MCS selection may be made, among other decisions.

### PRIOR ART REFERENCES

[1] Lucent, “Reverse Link Hybrid ARQ: Link Error Prediction Methodology Based on Convex Metric”, 3GGP2 TSGC WG3, C30-20030401-020, April 2003.
[2] Ericsson, “System-level evaluation of OFDM—further considerations”, 3GPP TSG_RAN WG1 #35, R1-031303, November 2003.
[3] Nortel, “Effective SIR Computation for OFDM system-level simulations”, 3GPP TSG-RAN WG1 #35, R1-031370, November 2003.
[4] Ericsson “Effective-SNR Mapping for Modeling Frame Error Rates in Multiple-state Channels”, 3GPP2-C30-20030429-010, November 2003.
[5] Alvarion, Motorola, “CINR measurements using the EESM method”, IEEE 802.16 Broadband Wireless Access Working Group, IEEE C802.16e-05/141r3, April 2005.

### SUMMARY OF THE INVENTION

It is the scope of the present invention to provide a system and method to effectively and practically compute the ECINR.

A key issue for accurate system-level evaluations is to be able to derive from an instantaneous channel state, such as the instantaneous CINR for each pilot sub carrier in case of an OFDM and/or OFDMA system, a corresponding bit-error rate (BER) or a packet error rate (PER). For frequency selective channels, CINR varies from subcarrier to subcarrier.

Measuring a channel behavior and calculating its average CINR, may not lead directly to PER or finding the preferred MCS;

Two channel realizations with the same average CINR may lead to substantially different PERs depending on the instantaneous channel variation.

Therefore, the average CINR provides a loose link error prediction for fading channels. To overcome this difficulty, it was proposed to exploit effective CINR, which is defined as AWGN- equivalent CINR, i.e. equivalent CINR in an Additive White Gaussian Noise (AWGN) channel that results in the same error rate.

The objective for ECINR is to translate all the channel-dependent factors to an equivalent AWGN channel, which results in a simple standardization for link adaptation.

This allows using this mapping along with AWGN assumptions, such as the effect of an increase in power and/or CINR/MCS threshold tables, in order to predict the Effect of different MCS and boosting (increasing the amplitudes of subcarriers and/or pilots) values.

Recently, several methods for ECINR calculation have been developed. One of them is EESM method (Prior art references: [3], [4], [5]). EESM is defined as a function that maps the channel realization, and power level to an effective CINR value that corresponds to the same PER in the AWGN channel.

In this application, a new scheme for effective CINR calculation is provided. An existing EESM method is generalized by introducing at least one additional parameter. The proposed scheme allows the evaluation of ECINR with enhanced accuracy.

Some of the prominent methods for ECINR calculation, may include:

### 1. EESM (Exponential Effective SINR Mapping)

This method is based on the Union-Chemoff bound of error probabilities (Prior art references: [2], [4], and references therein). The EESM method estimates the effective CINR employing formula:

$${Y}_{eff} = - β ln ( \frac{1}{N} {\sum }_{i = 1}^{N} {e}^{- \frac{{Y}_{i}}{β}} ) , \qquad ( 1 )$$

Where Yγᵢ i=1, . . . , N are per tone CINR values on a linear scale, and β is a function of MCS and FEC block size.

It can be noted that γY_{eff} is given on a linear scale. The parameter β is pre-determined experimentally by matching the PER or BER to an AWGN reference curve. Usually the Euclidian metric is used for the calibration.

### 2. CESM (Capacity Effective CINR Mapping)

This scheme is based on Shannon's channel capacity formula. The expression for CESM is given by:

$${Y}_{eff} = β [ {2}^{\frac{1}{N} {\sum }_{i = 1}^{N} {log}_{2} ( 1 + \frac{{Y}_{i}}{β} )} - 1 ] , \qquad ( 2 )$$

Where all the parameters in (2) are defined the same as in (1).

It is well known that CESM is less accurate than EESM.

### 3. MIESM (Mutual Information Effective CINR Mapping)

In this method, effective CINR is calculated according to formula:

$${γ}_{eff} = β \cdot {f}^{- 1} ( \frac{1}{N} {\sum }_{i = 1}^{N} f ( \frac{{γ}_{i}}{β} ) ) , \qquad ( 3 )$$

where f is a capacity mapping function that is calculated by maximizing the mutual information of a discrete memoryless channel for a continuous valued output. One of the forms proposed is prior art reference [1].

f may be defined as:

$$f ( σ ) = 1 - {\int }_{- ∞}^{∞} \frac{1}{\sqrt{2 πσ}} exp ( - \frac{1}{2 {σ}^{2}} {( v - \frac{{σ}^{2}}{2} )}^{2} ) {Log}_{2} ( 1 + {e}^{- v} ) , \qquad ( 4 )$$

In many cases, the ECINR computation should provide accurate results in a limited rage of PER values, corresponding to the requirements implied by the quality of service (QoS) of the communications link. Thus, a method that would provide enhanced accuracy in this range would be preferable. The ECINR calculation method suggested in this application is such.

According to current invention, generalization of the EESM method is implemented by introducing an additional parameter κ. Thus the standard EESM formula (1) turns to:

$${Y}_{eff} [ dB ] = \frac{10}{κ} log 10 [ - β ln ( \frac{1}{N} {\sum }_{i = 1}^{N} {e}^{- \frac{{( {Y}_{i} )}^{κ}}{β}} ) ] , \qquad ( 5 )$$

This novel method provides a more flexible approach for calculating the ECINR (γ_{eff}) wherein both κ and β can be set and/or calibrated, such as by link-level simulation—for providing a more accurate ECINR. Note that compare to observed ECINR methods the ECINR value in the proposed scheme is calculated in dB.

The proposed systems and methods demonstrate better and more stable results than the original EESM method for the required range of PER specified. For example, the novel ECINR evaluated according to a method of this invention may deviate from the reference AWGN PER by less than 1 dB probability larger than 0.95.

The proposed systems and methods can be used also for ECINR calculation for various transmission-receiving schemes such as Maximum Ratio Combining MRC, Space Time Coding STC, open-loop MIMO and/or closed loop MIMO. Modification may only be made in per-tone CINR calculation such as by adapting a per-tone CINR formula.

### BRIEF DESCRIPTION OF THE DRAWINGS

FIG. 1 describes a method for computing ECINR effectively and practically, based on two parameters.

FIG. 2 details communication system implementation with ECINR mechanism.

FIG. 3 illustrates CDFs of ECINR deviations for QPSK 1/2.

FIG. 4 illustrates CDFs of EMIR deviations for 16QAM 1/2.

### DETAILED DESCRIPTION OF THE INVENTION

The present invention will now be described by way of example, and with reference to the accompanying drawings.

### Method for Effectively and Practically Computing ECINR:

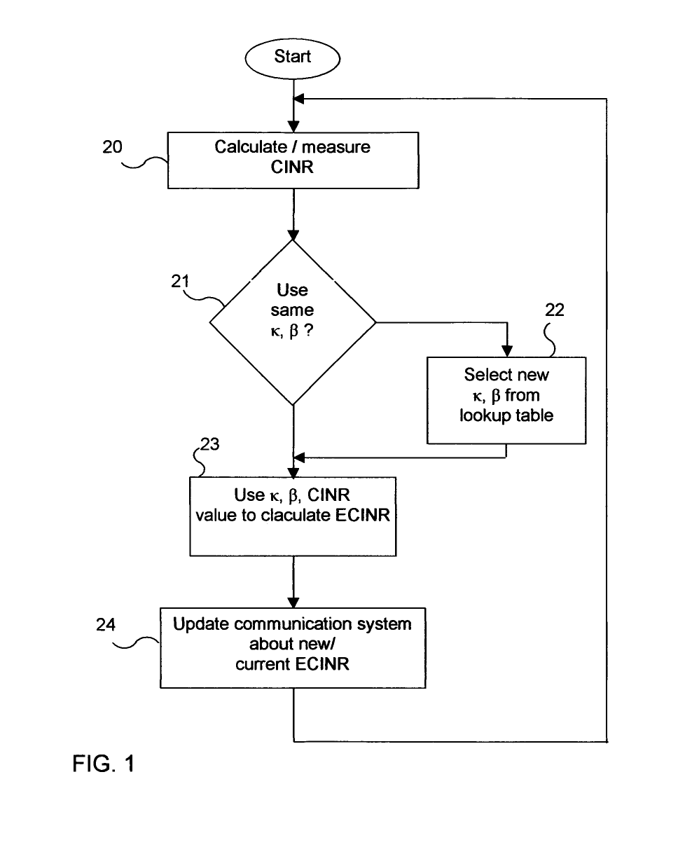

FIG. 1 describes a method for effectively and practically computing ECINR, this method can include the following steps:

1. Calculate or measure instantaneously CINR (γᵢ) for each channel and/or bandwidth and/or signal of interest 20.

Any of these options may also be referred herein as per-tone CINR value.

γᵢ i=1, . . . , N may be marked as the per tone CINR values on a linear scale.

For example, it may be desired to calculate per-tone CINR value for each pilot subcarrier, such as for a communication protocol/system where there are known pilots at fixed frequencies.

A measured or known signal may be a pilot subcarrier in case of an OFDM and/or OFDMA system and/or other indicative signal or packet of a communication system and/or other type of subcarrier or a signal carrying information. The signal can be compared to noise and/or interference levels, to determine the CINR.

A packet and/or frame's data or definitions may be taken to define CINR parameters.

CINR may be calculated in any manner to that known in the art, however additional methods for calculating or estimating the CINR values may be used as well.

In addition, the CINR may be derived from data that is available at a communication system, thus it may be possible to derive or provide the CINR values without performing additional measurements to those already made at the given communication system.

In a preferred method, such as in OFDMA systems, the per-tone CINR (γᵢ) for a Single Input Single Output (SISO) scheme, can be evaluated using the following equation:

$${Y}_{i} = \frac{{\vert {h}_{i} \vert}^{2}}{{σ}^{2}} , \qquad ( 6 )$$

Where hᵢ is the channel value at i-th subcarrier (such as measured voltage at a certain frequency, such as at pilot/subcarrier's frequency) and σ is the noise intensity.
2. For a certain modulation-coding scheme (MCS) and/or FEC block size used, the parameters κ and β are selected 22, such as from a predefined lookup table. Preferably, both κ and β were set and/or calibrated in advance, such as by link-level simulations—for providing a more accurate ECINR;

Or_{[D.E.1]} the lookup table is already provided based on such link level simulations, which could be done just once for creating the lookup table, then the same κ and β can be used 21.

3. ECINR is calculated 23, by taking the values of the κ and β parameters from step 2, together with the CINR (γᵢ) values of step 1, and placing them in the generalized EESM formula (5_{[D.E.2]}):

$${Y}_{eff} [ dB ] = \frac{10}{κ} log 10 [ - β ln ( \frac{1}{N} {\sum }_{i = 1}^{N} {e}^{- \frac{{( {Y}_{i} )}^{κ}}{β}} ) ] , \qquad ( 7 )$$

The result of formula 7 is the ECINR γ_{eff}, which is given here on a logarithmic scale. It can be possible to perform operations on a linear scale with and/or with logarithmic values as well.

In a preferred method, the parameters β, κ are pre-determined experimentally by matching the PER or BER to an AWGN reference curve. Usually the Euclidian metric is used for the calibration.

4. The communication system is updated with the calculated ECINR value 24. It may be possible to update one or more BS's, MS's and/or any other interface or device—for adapting the communication accordingly.

Thus, it may be possible to select a preferred MCS and/or FEC method or change any other parameter used.

It may be possible to use a pre-set algorithm for deciding whether to change any parameter such as MCS, EEC and/or Pilots Boosting, according to calculated ECINR and current system setup.

The whole process can be repeated, such as for each frame, and/or according to system's requirements.

### *End of Method*

### Parameters Calibration

The parameters β and κ adequate for each MCS and FEC block size are obtained by means of simulations, in which benchmark channel models (such as ITU's Ped. A and Veh. B) are emulated. For each MCS and FEC block size an independent simulation is performed both of the AWGN and benchmark channels.

The BER or PER results of each benchmark simulation are compared to those of the AWGN channel and the PCINR values for which a target BER or PER are met are recorded. Then the Generalized EESM method is applied to the per tone PCINR resulting from the benchmark channel simulation with different predefined ranges for β and κ. These ranges may be viewed as the search space.

The most suitable β and κ are determined such that the Generalized EESM ECINR result matches within a predefined accuracy that of the corresponding AWGN channel.

For the case of Veh. A 60 km/h channel with QPSK rate 1/2 CTC and FEC size of 480 bits, the customary range for β and κ (search space) is 1<κ<4 and 1<β<100, on a linear scale. The optimum values resulting from the aforementioned calibration process where \hat{κ}=2.7, and \hat{β}=3.4.

Since the optimization problem at hand is not convex, other pairs of β and κ may lead to similar performance.

The proposed method can also be used for ECINR calculation for any various transmission-receiving schemes such as MRC, STC, open-loop MIMO or closed loop MIMO. In order to adjust one or more of the methods or systems described herein, it may only be required to change the per-tone CINR calculation. For example, the per-tone CINRs for MRC scheme for the system with 1 transmit antenna and M receive antennae can be calculated as follows (post processing per tone CINR):

$${Y}_{i} = \frac{{\sum }_{K = 1}^{M} {\vert {h}_{k , i} \vert}^{2}}{{σ}^{2}} , \qquad ( 8 )$$

Wherein h_{k,i} is the value of k-th channel at i-th subcarrier, and σ is the noise intensity.

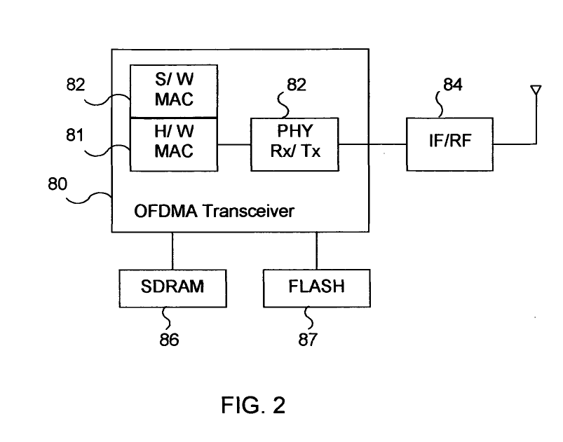

FIG. 2 details a communication system implementation using the ECINR mechanism for improved performance.

### HW and SW Implementation

Since the ECINR calculation is based on numerous samples (usually OFDM subcarriers at specific symbols), and the calculation should be repeated for various MCS and MIMO modes, the proposed method is most suited for HW implementation (e.g. VHDL module).

For instance, for a WiMAX frame (SmSec in duration), an order of 24 independent calculations of ECINR (for various MCS, EEC sizes and MIMO modes) may be required. Each calculation makes use of typically hundreds to thousands per tone measurements. Thus, the computational burden implied by the Generalized EESM is far too large for SW implementation. Moreover, the fixed nature of the method also encourages HW implementation.

However, in some applications, as low rate communications systems the Generalized EESM may also be implemented by mean of SW.

### Simulation Results:

In this section the simulation results for the proposed methods versus the performance of prior art EESM methods are detailed. The empirical cumulative distributions of the deviations of the ECINR were computed and evaluated by the EESM method from the equivalent CINR of an AWGN channel.

The same was done for the proposed methods and the results were compared. Simulations were ran for numerous realizations of the Vehicular A 60 km/h, Vehicular A 120 km/h and Pedestrian B 3 km/h WiMAX benchmark channels. Since the results are very similar for all channels investigated, only the results for the Vehicular A 60 km/h are posted below.

Additional parameters are CTC encoding, and FEE blocks of 480 bits.

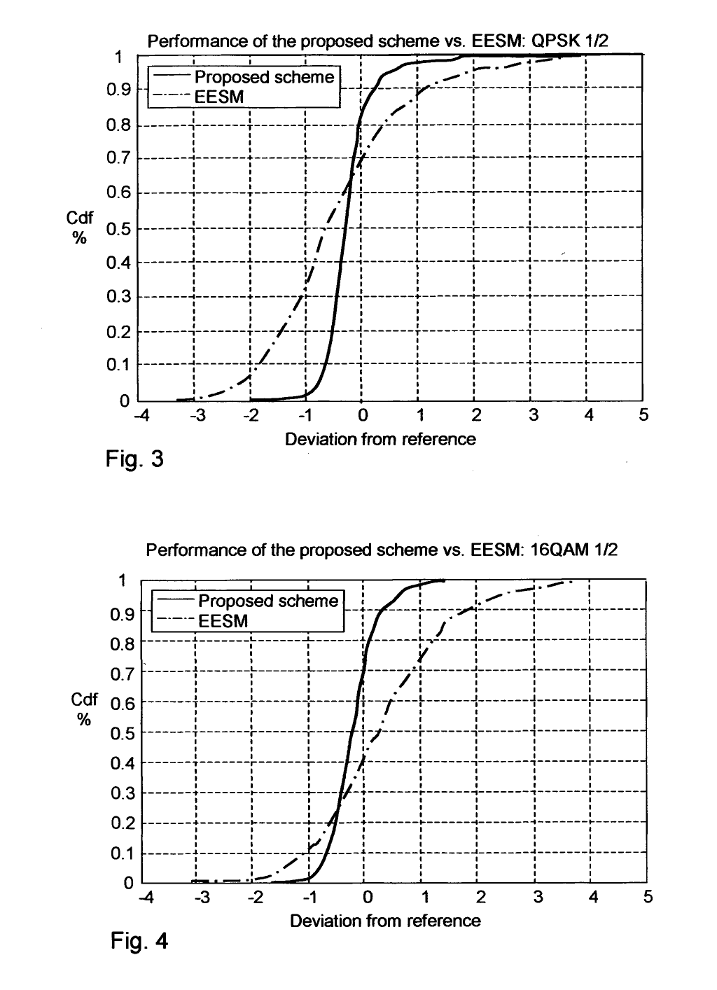

The dotted graphs in FIGS. 3 and 4 correspond to the performance of the original EESM method and the continuous graphs—to the novel proposed scheme.

FIGS. 3, 4 may illustrate the superior performance of the proposed method over the original EESM scheme.

It will be recognized that the foregoing is but one example of a device and method within the scope of the present invention, and that various modifications will occur to those skilled in the art upon reading the disclosure set forth hereinbefore, together with the related drawings.

1. A method for computing ECINR in communication systems comprising the steps:
A. Calculating or measuring instantaneously CINR (γᵢ) or per-tone CINR value for each channel and/or bandwidth and/or signal of interest;
B. Selecting κ and β parameters according to MCS and/or FEC block size used;
C. Calculating ECINR by using the CINR (γᵢ) or per-tone CINR values and the κ and β parameters with a generalized EESM formula;
D. Providing a communication system the updated γ_{eff} which is the ECINR value.

2. The method according to claim 1, wherein the generalized EESM formula of step C is:
$${Y}_{eff} [ dB ] = \frac{10}{κ} log 10 [ - β ln ( \frac{1}{N} {\sum }_{i = 1}^{N} {e}^{- \frac{{( {Y}_{i} )}^{κ}}{β}} ) ]$$

3. The method according to claim 1 or 2, wherein the κ and β parameters are kept in a lookup table.

4. The method according to claim 1, 2 or 3, wherein the communication system is an OFDMA communication system.
